(19) United States
(12) Patent Application Publication
(10) Pub. No.: US 2012/0131014 A1
(43) Pub. Date: May 24, 2012

(54) SYSTEMS AND METHODS FOR INTERPOLATING ALTERNATIVE INPUT SETS BASED ON USER-WEIGHTED VARIABLES

(76) Inventor: Eric Williamson, Willow Spring, NC (US)

(21) Appl. No.: 12/951,881

(22) Filed: Nov. 22, 2010

(51) Int. Cl. G06F 17/30

(52) U.S. Cl. 707/748; 707/E17.084

(57) ABSTRACT

Embodiments relate to systems and methods for interpolating alternative input sets based on user-weighted variables. A database can store sets of operational data, such as financial, medical, climate or other information. For given data, a portion of the input data can be known or predetermined, while for a second portion can be unknown and subject to interpolation. The interpolation engine can generate a conformal interpolation function and interpolated input sets that map to a set of target output data. The operator can access a view or dialog on the set of known (or interpolated) input data to manually select different weights to be applied to one or more variables in the various input sets. By applying different groups of weights, the operator can study or simulate the effects of changing the relative importance of different inputs, and generate a series of different inputs and outputs based on those varying weights.

### FIELD

The invention relates generally to systems and methods for interpolating alternative input sets based on user-weighted variables, and more particularly, to platforms and techniques for accessing sets of historical or existing input data, interpolating missing or undetermined components of the input data to map to a desired target output, and accept a set of user-supplied weights to be applied to the various input classes to generate alternative interpolated input sets, grouped as series or as other collections.

### BACKGROUND

In the fields of computational modeling and high performance computing, modeling platforms are known which contain a modeling engine to receive a variety of modeling inputs, and then generate a precise modeled output based on those inputs. In conventional modeling platforms, the set of inputs are precisely known, and the function applied to the modeling inputs is precisely known, but the ultimate results produced by the modeling engine are not known until the input data is supplied and the modeling engine is run. For example, in an econometric modeling platform, inputs for a particular industry like housing can be fed into a modeling engine. Those inputs can include, for instance, prevailing finance rates, employment rates, average new-home costs, costs of building materials, rate of inflation, and other economic or other variables that can be fed into the modeling engine which is programmed or configured to accept those inputs, apply a function or other processing to those inputs, and generate an output such as projected new-home sales for a given period of time. Those results can then be used to analyze or forecast other details related to the subject industry, such as predicted sector profits or employment.

In many real-life analytic applications, however, the necessary inputs for a given subject or study may not be known, while, at the same time, a desired or target output may be known or estimated with some accuracy. For instance, the research and development (R&D) department of a given corporation may be fixed at the beginning of a year or other budget cycle, but the assignment or allocation of that available amount of funds to different research teams or product areas may not be specified by managers or others. In such a case, an analyst may have to manually estimate and “back out” distributions of budget funds to different departments to begin to work out a set of component funding amounts that will, when combined, produce the already-known overall R&D or other budget. In performing that interpolation, the analyst may or may not be in possession of some departmental component budgets which have themselves also been fixed, or may or may not be in possession of the computation function which will appropriately sum or combine all component funds to produce the overall predetermined target budget. Adjustment of one component amount by hand may cause or suggest changes in other components in a ripple effect, which the analyst will then have to examine or account for in a further iteration of the same manual estimates.

In cases where an interpolation study is conducted, the ultimate selection of interpolated inputs and other data used to perform the interpolation may itself contain implied information regarding the appropriate breakdowns of the data, judgments about which inputs should receive priority compared to others, and other attributes of the eventual input breakouts and the interpolation function developed for that data. In cases, the values for the interpolated inputs may be introduced by an analyst or other user acting to adjust those interpolated values, to determine alternative solutions.

In cases, it may be helpful or necessary for the operator of an interpolation tool to manually explore possible alterations to the input, output, and/or interpolated data. That is, while conducting an interpolation study, the operator may wish to take for instance the historical or existing known inputs, and change or adjust them to observe the effects on the remaining interpolated inputs, the initial output, and/or other components of the data. The operator may wish to make selective or manual adjustments for a variety of purposes, for instance, to explore “what if”-type scenarios, to recreate additional known or inferred historical data not captured in an existing data set, and/or to study the effects of changing the relative importance of various components of the input data by weighting or scaling that data on selective basis. It may be desirable to provide systems and methods for interpolating alternative input sets based on user-weighted variables, in which an operator can supply, manipulate, and analyze the effects of selective weights or other adjustments to inputs, and observe the corresponding response of interpolated values or other outputs.

### DESCRIPTION OF DRAWINGS

FIG. 1 illustrates an overall network architecture which can support the generation of interpolated input sets based on a target output, according to various embodiments of the present teachings;

FIGS. 2A-2B illustrate various exemplary sets of input data, and series of sets of input data, that can be produced by interpolation techniques whose output and other data can be used in systems and methods for interpolating alternative input sets based on user-weighted variables, according to various embodiments;

FIG. 3 illustrates an exemplary hardware configuration for client machine which can host or access interpolation processes whose output and related data can be used in systems and methods for interpolating alternative input sets based on user-weighted variables, according to various embodiments;

FIG. 4 illustrates a flowchart for overall interpolation, function determination, and other processing that can be used to produce conformal input sets based on a target output that can be used in systems and methods for interpolating alternative input sets based on user-weighted variables, according to various embodiments;

FIG. 5 illustrates an exemplary network configuration that can be used in conjunction with systems and methods for interpolating alternative input sets based on user-weighted variables, according to various embodiments of the present teachings;

FIG. 6 illustrates an exemplary network configured to perform selective weighting operations in systems and methods for interpolating alternative input sets based on user-weighted variables, according to various embodiments; and

FIG. 7 illustrates a flowchart of exemplary training and other processing that can be used in connection with systems and methods for interpolating alternative input sets based on user-weighted variables, according to various embodiments.

### DESCRIPTION

Embodiments relate to systems and methods for interpolating, alternative input sets based on user-weighted variables. More particularly, embodiments relate to platforms and techniques that can be invoked by a user to extract, view, navigate and manipulate interpolation data including one or more predetermined sets of input data, one or more sets or series of interpolated input data, and/or other data to apply user-supplied weights, scalings, and/or other functions to the values of those data objects. In aspects, the ability to apply weights or other adjustments to one or more pieces of the component data operated on by the interpolation engine and/or associated weighting tool may allow an analyst or other operator to examine hypothetical or alternative versions of data, to create or explore different interpolation scenarios and resulting outcomes.

In terms of the interpolated data which the weighting module, tool, or logic can access and operated on, that underlying data can be generated by one or more underlying interpolation platforms which access or retrieve a set of historical, operational, archival, or other operative data related to captured technical, financial, medical, or other operations, and supply that operative data to an interpolation engine. The interpolation engine can also be supplied with or can access a set of target output data, for purposes of generating a set of estimated, approximated, inferred, or otherwise interpolated inputs that can be supplied to the interpolation engine to produce the target output. Thus, for instance, in an illustrative context of a climate modeling platform, a collection or set of historical input data, such as ocean temperatures, air temperatures, land temperatures, average wind speed and direction, average cloud cover, and/or other inputs or factors can be accessed or retrieved from a data store. The data store can for the interpolation platform can for instance include records of those or other variables for each year of the last ten years, along with an output or result associated with those inputs, such as ocean level or polar cap area for each of those years or other series. In aspects, a partial set or subset of predetermined or fixed values for the same inputs can be supplied to the interpolation engine, such as predicted or assumed arctic temperatures, for the current year. The interpolation engine can also receive a set of target output data, such as the expected or projected ocean level or polar cap area for the current year. According to embodiments, the interpolation engine can then generate an interpolation function, and generate a set of interpolated inputs, such as air temperature, land temperature, average wind speed and direction, average cloud cover, and/or other remaining inputs whose values are unspecified, but which can be interpolated to produce values which when supplied as input to the interpolation engine can produce the set of target output data.

In cases, an analyst, operator, and/or other user may wish to generate and explore variations, modifications, and/or alternatives to the historical input data and/or the interpolated portions of that data, or possibly of the output data. In such scenarios, a user can invoke a weighting tool hosted in the interpolation engine, in order to a weighting dialog to input user-selected or specified weights to apply to one or more of the set of predetermined data, and/or interpolated input data or other data. The user can pursue different scenarios using different sets of weights that they have entered, to compare different outcomes or series of input and output data. In an economic study investigating the effects of interest rates on housing sales, for example, a user may assign a weight of 1.1 (i.e., increase the value or significance by 10%) to the prevailing interest rate for a certain category of housing over the first quarter of 2009, while inputting or assigning a weight of 9 (i.e., decrease the value or significance) to the amount of housing stock available in the same quarter. The user can then view the results of that adjustment on the predetermined output data to examine whether that output remains at its initial or desired value, and/or to see the effects on the set of interpolated input data, such as for instance average time on market for a housing unit, due to that altered scenario. Other variations or combinations of data weightings of course are possible.

In cases, the interpolation engine, weighting tool, and/or other logic can generate different combinations of the set of interpolated input data in different generations, series, and/or other alternative values or groupings, to permit an analyst or other user to manipulate the input values, to observe different ramifications of different weights that may be applied to parts of, and/or time periods for, the set of interpolated inputs and/or other components of the data. The user of the weighting tool can be presented with a weighting dialog or other interface to manipulate the weights, scales, and/or other modifiers to be applied to the set of interpolated input values, and select or adjust those values (and/or the interpolation function used to generate those values). The analyst or other user can thereby determine scenarios, sets of weights to be applied to the known inputs or other types of data, and examine the effects on the output data, to determine for instance whether the known output data can be maintained or maintained within desired ranges under different weighting conditions. The ability to analyze and derive input sets under different weights, time periods for those weights, and/or other selective adjustments may permit an operator to explore or derive new series of input data that may produce already-known or desired outputs, and/or other outputs if those inputs are varied by relative importance or weight. In aspects, the interpolation function that may accept the weighted input values and still maintain or output the set of known or fixed output data can also be identified or generated.

After completion of those or other types of interpolation studies or reports, according to the present teachings, the sets of weights, the sets of time periods for those weights, the set of resulting interpolated input values and other data can be stored to a local or remote data store. According to embodiments of the present teachings, that data can then be accessed or retrieved by the same interpolation platform and/or weighting tool, and/or other tools or users, for instance to perform further interpolation or modeling activity consistent with the weighted and/or interpolated values and target output data.

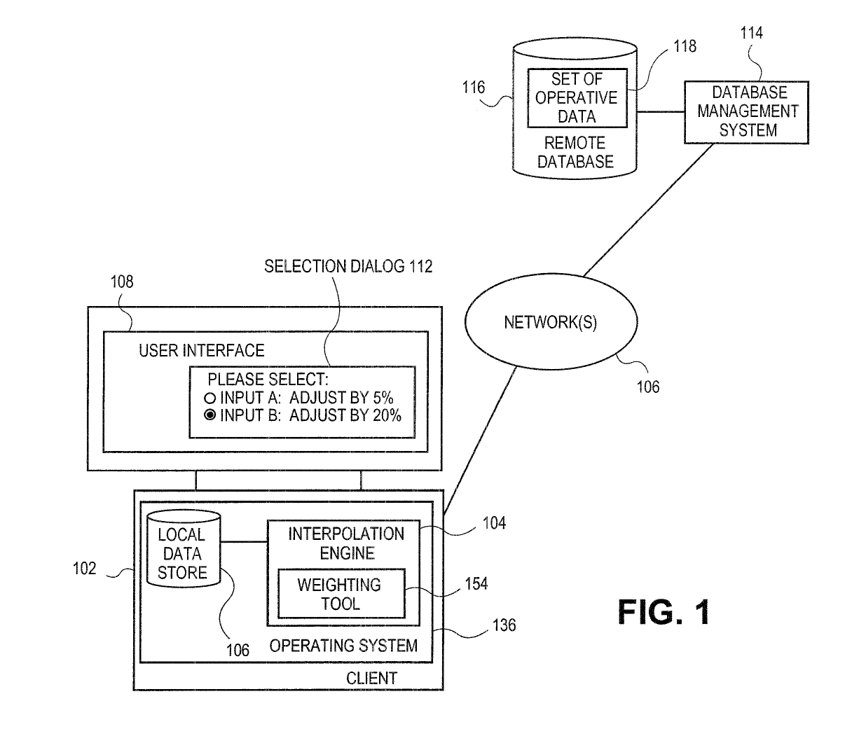

Consistent with the foregoing, in embodiments as shown in FIG. 1, in accordance with embodiments of the invention, a user can operate a client 102 which is configured to host an interpolation engine 104, to perform interpolation and other analytic operations as described herein. In aspects, while embodiments are described in which interpolation engine 104 is described to operate on historical data to interpolate or fill in missing values or parameters, in embodiments, it will be understood that interpolation engine 104 can in addition or instead operate to produce extrapolated data, reflecting expected future values of inputs and/or outputs. In aspects, the client 102 can be or include a personal computer such as a desktop or laptop computer, a network-enabled cellular telephone, a network-enabled media player, a personal digital assistant, and/or other machine, platform, computer, and/or device. In aspects, the client 102 can be or include a virtual machine, such as an instance of a virtual computer hosted in a cloud computing environment. In embodiments as shown, the client 102 can host or operate an operating system 136, and can host or access a local data store 106, such as a local hard disk, optical or solid state disk, and/or other storage. The client 102 can generate and present a user interface 108 to an analyst or other user of the client 102, which can be a graphical user interface hosted or presented by the operating system 136. In aspects, the interpolation engine 104 can generate a selection dialog 112 to the user via the user interface 108, to present the user with information and selections related to interpolation and other analytic operations.

In embodiments as likewise shown, the client 102 and/or interpolation engine 104 can communicate with a remote database management system 114 via one or more networks 106. The one or more networks 106 can be or include the Internet, and/or other public or private networks. The database management system 114 can host, access, and/or be associated with a remote database 116 which hosts a set of operative data 118. In aspects, the database management system 114 and/or remote database 118 can be or include remote database platforms such the commercially available Oracle™ database, an SQL (structured query language) database, an XML (extensible markup language) database, and/or other storage and data management platforms or services. In embodiments, the connection between client 102 and/or the interpolation engine 104 and the database management system 114 and associated remote database 116 can be a secure connection, such as an SSL (secure socket layer) connection, and/or other connection or channel. The interpolation engine 104 can access the set of operative data 118 via the database management system 114 and/or the remote database 116 to operate, analyze, interpolate and map the set of operative data 118 and other data sets to produce or conform to a set of target output data 120. In aspects, the predetermined or already-known set of target output data 120 can be stored in set of operative data 118, can be received as input from the user via selection dialog 112, and/or can be accessed or retrieved from other sources.

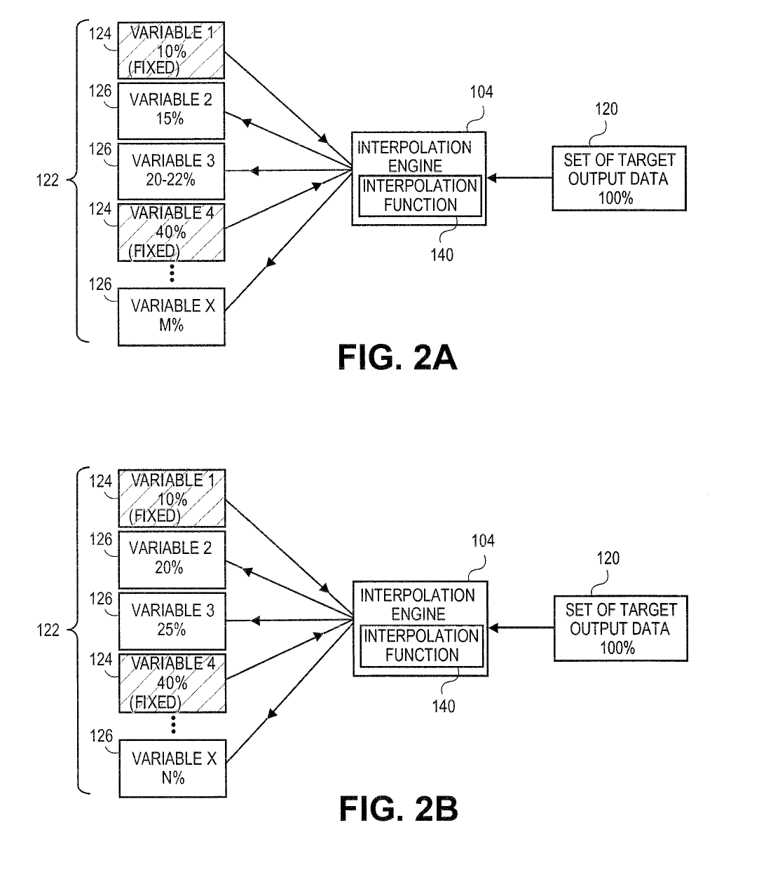

In embodiments, and as shown in FIGS. 2A-2B, the interpolation engine 104 can, in general, receive the set of target output data 120, and operate on that data to produce a conformal mapping of a set of combined input data 122 to generate an output of the desired set of target output data. As for instance shown in FIG. 2A, the set of combined input data 122 can, in cases, comprise at least two component input data sets or subsets. In aspects as shown, the set of combined input data 122 can comprise or contain a set of predetermined input data 124. The set of predetermined input data 124 can consist of data that is predetermined or already known or captured, for instance by accessing the set of operative data 118, and/or by receiving that data from the user as input via the selection dialog 112. In aspects, the set of predetermined input data 124 can include variables or other data which are already known to the user, to other parties, or has already been fixed or captured. In the case of a medical epidemiology study, for example, the set of predetermined input data 124 can include the number of vaccination doses available to treat an influenza or other infectious agent. For further example, in cases where the set of combined input data 122 represents the components of a corporate or government financial budget, the set of predetermined input data 124 can reflect the percentages (as for instance shown), for example to be allocated to different departments or agencies. It will be appreciated that other percentages, contributions, expressions, and/or scenarios or applications can be used.

In aspects, the interpolation engine 104 can access and process the set of predetermined input data 124 and the set of target output data 120, to generate a set of interpolated input data 126 which can produce the set of target output data 120 via an interpolation function 104. For instance, if the set of target output data 120 represents a total budget amount for an entity, then the set of interpolated input data 126 can reflect possible, approximate, or suggested values or percentages of that total funded amount that the interpolation engine 104 can allocate to various departments, using the interpolation function 140. Again, as noted the interpolation function 140 can be determined by interpolation engine 104 to generate the set of target output data 120, as predetermined by the user or otherwise known or fixed. In embodiments, interpolation techniques, functions, and/or other related processing as described in co-pending U.S. application Ser. No. 12/872,779, entitled “Systems and Methods for Interpolating Conformal Input Sets Based on a Target Output,” filed on Aug. 31, 2010, having the same inventor as this application, assigned or under obligation of assignment to the same entity as this application, and incorporated by reference in its entirety herein, can be used in determining interpolation function 140, configuring and/or executing interpolation engine 104, and/or performing other related operations. In aspects, the interpolation engine 104 can also comprise, host, and/or access a weighting tool 154, which may be used to open or initiate a weighting dialog and receive user inputs, selections, and/or other manipulations to the set of predetermined input data 124 and/or other data components, to generate different or alternative data series for comparative examination or other purposes, as described herein.

The following applications, scenarios, applications, or illustrative studies will illustrate the interpolation action or activity that may be performed by the interpolation engine 104, according to various embodiments. In cases, again merely for illustration of exemplary interpolation analytics, the set of operative data 118 can be or include data related to medical studies or information. Thus for instance, the set of operative data 118 can include data for a set or group of years that relate to public health issues or events, such as the population-based course of the influenza seasons over that interval. The set of operative data can include variables or inputs that were captured or tracked for the influenza infection rate in the population for each year over the given window. Those variables or inputs can be or include, for instance, the percentage of the population receiving a public vaccine by Week 10 of the flu season, e.g. 20%, the age cohorts of the patients receiving the vaccine, the strain of the influenza virus upon which the vaccine is based, e.g. H5N5, the infectivity or transmission rate for a given infected individual, e.g. 3%, the average length of infectious illness for the infected population, e.g. 10. days, and/or other variables, metrics, data or inputs related to the epidemiology of the study. In aspects, the output or result of those tracked variables can be the overall infection rate for the total population at peak or at a given week or other time point, such as 40%. Other outputs or results can be selected. Those inputs and output(s) can be recorded in the set of operative data 118 for a set or group of years, such as for each year of 2000-2009, or other periods. In aspects, data so constituted can be accessed and analyzed, to generate interpolated data for current year 2010, although the comparable current inputs are not known or yet collected. In the current year (assumed to be 2010), one or more of the set of predetermined variables 124 may be known, such as, for instance, the vaccination rate of because yearly stocks are known or can be reliably projected, e.g. at 25%. In addition, an analyst or other user may specify a set of target output data 120 that can include the overall infection rate for the population the year under study, such as 35% at peak. In cases of this illustrative type, the interpolation engine 104 can access or receive the overall infection rate (35% peak) as the set of predetermined output data 120 or a part of that data, as well as the vaccination rate (25%) as the set of predetermined input data 124 or part of that data. In aspects, the interpolation engine 104 can access the collected historical data (for years 2000-2009) to analyze that data, and generate an interpolation function 140 which operates on the recorded inputs to produce the historical outputs (overall infection rate), for those prior years, either to exact precision, approximate precision, and/or to within specified margins or tolerance. The interpolation engine 104 can then access or receive the set of target output data 120 for the current (2010) year (35% peak infection), the set of predetermined input data (25% vaccination rate), and/or other variables or data, and utilize the interpolation function 140 to generate the set of interpolated input data 126. In the described scenario, the set of interpolated input data 126 generated or produced by the interpolation engine 104 can include the remaining unknown, speculative, uncollected, or otherwise unspecified inputs, such as the percentage of the population receiving a public vaccine by Week 10 of the flu season, e.g. 25%, the age cohorts of the patients receiving the vaccine, the strain of the influenza virus upon which the vaccine is based, e.g. H1N5, the infectivity or transmission rate for a given infected individual, e.g. 4%, the average length of infectious illness for the infected population, e.g. 9 days, and/or other variables, metrics, data or inputs. In aspects, the interpolation engine 104 can generate or decompose the set of interpolated input data 126 to produce the set of target output data 120 (here 35% peak infection) to exact or arbitrary precision, and/or to within a specified margin or tolerate, such as 1%. Other inputs, outputs, applications, data, ratios and functions can be used or analyzed using the systems and techniques of the present teachings.

In embodiments, as noted the interpolation function 140 can be generated by the interpolation engine 104 by examining the same or similar variables present in the set of operative data 118, for instance, medical data as described, or the total fiscal data for a government agency or corporation for a prior year or years. In such cases, the interpolation engine 104 can generate the interpolation function 140 by assigning the same or similar categories of variables a similar value as the average of prior years or sets of values for those same variables, and then perform an analytic process of those inputs to derive set of target output data 120 as currently presented. The interpolation engine 104 can, for example, apply a random perturbation analysis to the same variables from prior years, to produce deviations in amount for each input whose value is unknown and desired to be interpolated. When combinations of the set of predetermined input data 124 and set of interpolated input data 126 are found which produce the set of target output data 120, or an output within a selected margin of set of target output data 120, the user can operate the selection dialog 112 or otherwise respond to accept or fix those recommended or generated values.

In cases, and as for instance illustrated in FIG. 2B, the set of combined input data 122 can be generated to produce the set of target output data 120 may not be unique, as different combinations of the set of predetermined input data 124 and set of interpolated input data 126 can be discovered to produce the set of target output data 120 either exactly, or to within specified tolerance. In such cases, different versions, generations, and/or series of set of combined input data 122 can be generated that will produce the set of target output data 120 to equal or approximately equal tolerance. For example, in cases where the set of operative data 118 relates to an epidemiological study, it may be found that a limit of 20 million cases of new infection during a flu season can be produced as the set of target output data 120 by applying 40 million doses of vaccine at week 6 of the influenza season, or can be produced as a limit by applying 70 million doses of vaccine at week 12 of the same influenza season. Other variables, operative data, ratios, balances, interpolated inputs, and outputs can be used or discovered. In embodiments, when the possible conformal set of interpolated inputs 126 is not unique, the interpolation engine 104 can generate a set of interpolated input series, each series containing a set of interpolated input data 126 which is different and contains potentially different interpolated inputs from other conformal data sets in the set of interpolated input series. In cases where such alternatives exist, the interpolation engine 104 can generate and present the set of interpolated input series, for instance, in series-by-series graphical representations or otherwise, to select, compare, and/or manipulate the results and values of those respective data sets. In embodiments, the analyst or other user may be given a selection or opportunity to choose one set of interpolated input data 126 out of the set of interpolated input series for use in their intended application, or can, in embodiments, be presented with options to continue to analyze and interpolate the set of operative data 118, for example to generate new series in the set of interpolated input series. Other processing options, stages, and outcome selections are possible.

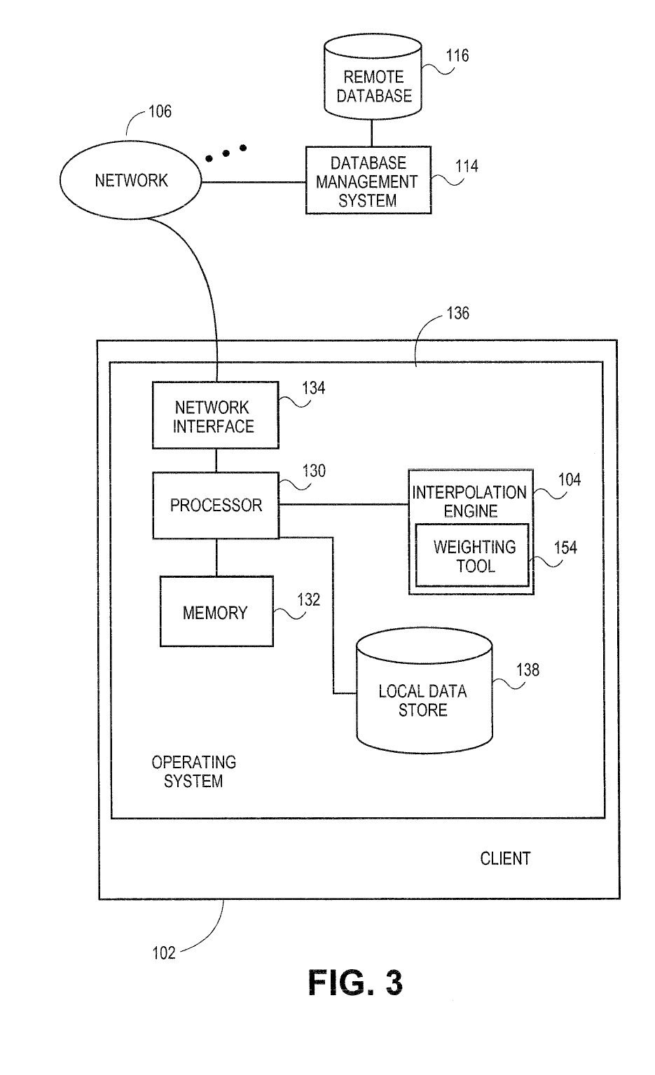

FIG. 3 illustrates an exemplary diagram of hardware and other resources that can be incorporated in a client 102 that can host interpolation engine 104, weighting dialog 148, weighting tool 154, and/or other logic or resources, and/or otherwise be used in connection with systems and methods for interpolating alternative input sets based on user-weighted variables, according to embodiments. In aspects, the client 102 can be or include a personal computer, a network enabled cellular telephone, or other networked computer, machine, or device. In embodiments as shown, the client 102 can comprise a processor 130 communicating with memory 132, such as electronic random access memory, operating under control of or in conjunction with operating system 136. Operating system 136 can be, for example, a distribution of the Linux™ operating system, the Unix™ operating system, or other open-source or proprietary operating system or platform. Processor 130 can also communicate with the interpolation engine 104 and/or a local data store 138, such as a database stored on a local hard drive. Processor 130 further communicates with network interface 134, such as an Ethernet or wireless data connection, which in turn communicates with one or more networks 106, such as the Internet or other public or private networks. Processor 130 also communicates with database management system 114 and/or remote database 116, such as an Oracle™ or other database system or platform, to access set of operative data 118 and/or other data stores or information. Other configurations of client 102, associated network connections, storage, and other hardware and software resources are possible. In aspects, the database management system 114 and/or other platforms can be or include a computer system comprising the same or similar components as the client 102, or can comprise different hardware and software resources.

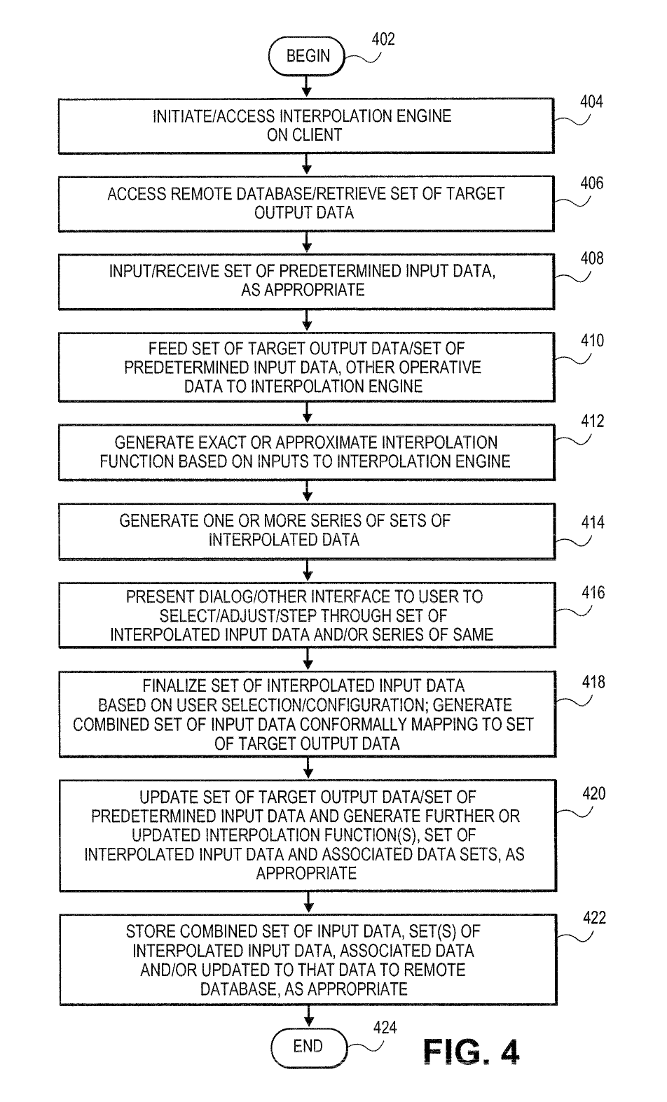

FIG. 4 illustrates a flowchart of overall processing to generate interpolation functions, sets of interpolated data, and other reports or information, according to various embodiments of the present teachings. In 402, processing can begin. In 404, a user can initiate and/or access the interpolation engine 104 on client 102, and/or through other devices, hardware, or services. In 406, the user can access the remote database 116 via the database management system 114 and retrieve the set of target output data 120 and/or other associated data or information. In 408, the interpolation engine 104 can input or receive the set of predetermined input data 124, as appropriate. In embodiments, the set of predetermined input data 124 can be received via a selection dialog 112 from the user or operator of client 102. In embodiments, the set of predetermined input data 124 can in addition or instead be retrieved from the set of operative data 116 stored in remote database 116, and/or other local or remote storage or sources. In aspects, the set of predetermined input data 124 can be or include data that is already known or predetermined, which has a precise target value, or whose value is otherwise fixed. For instance, in cases where the set of operative data 118 relates to an undersea oil reserve in a hydrology study, the total volume of oil stored in a reservoir can be known or fixed, and supplied as part of the set of predetermined input data 124 by the user or by retrieval from a local or remote database. In 410, the set of target output data 120, the set of predetermined input data 124, and/or other data in set of operative data 118 or other associated data can be fed to interpolation engine 104.

In 412, the interpolation engine 104 can generate the interpolation function 140 as an exact or approximate function that will generate output conforming to the set of target output data 120, as an output. In aspects, the interpolation function 140 can be generated using techniques such as, for instance, perturbation analysis, curve fitting analysis, other statistical analysis, linear programming, and/or other analytic techniques. In aspects, the interpolation function 140 can be generated to produce an approximation to the set of target output data 120, or can be generated to generate an approximation to set of target output data 120 to within an arbitrary or specified tolerance. The interpolation function 140 can also, in aspects, be generated to produce set of target output data 120 with the highest degree of available accuracy. In 414, the interpolation engine 104 can generate one or more subsets of interpolated input data 126, and/or one or more set of interpolated input series 128 containing individual different combinations of subsets of interpolated input data 126. In aspects, the set of interpolated input data 126 and/or the set of interpolated input series 128 can be generated by applying the set of target output data 120 to the set of predetermined input data 124 and filling in values in the set of interpolated input data 126 which produce an output which conforms to the set of target output data 120, exactly or to within a specified tolerance range. In aspects, the set of interpolated input data 126 and/or the set of interpolated input series 128 can be generated by producing sets of possible interpolated inputs which are then presented to the user via the selection dialog 112, for instance to permit the user to accept, decline, or modify the values of set of interpolated input data 126 and/or the set of interpolated input series 128.

In 416, the interpolation engine 104 can present the selection dialog 112 to the user to select, adjust, step through, and/or otherwise manipulate the set of interpolated input data 126 and/or the set of interpolated input series 128, for instance to allow the user to view the effects or changing different interpolated input values in those data sets. For example, in a case where the set of operative data 118 relates to financial budgets for a corporation, the user may be permitted to manipulate the selection dialog 112 to reduce the funded budget amount for one department, resulting in or allowing an increase in the budget amounts for a second department or to permit greater investment in IT (information technology) upgrades in a third department. In aspects, the selection dialog 112 can permit the adjustment of the set of interpolated input data 126 and/or set of interpolated input series 128 through different interface mechanisms, such as slider tools to slide the value of different interpolated inputs through desired ranges. In 418, the user can finalize the set of interpolated input data 126, and the interpolation engine 104 can generate the resulting combined set of input data 122 which conformally maps to the set of target output data 120. In 420, the set of target output data 120, set of predetermined input data 124, and/or other information related to the set of operational data 116 and the analytic systems or phenomena being analyzed can be updated. The interpolation engine 104 and/or other logic can generate a further or updated interpolation function 140, a further or updated set of interpolated input data 126, and/or an update to other associated data sets in response to any such update to the set of target output data 120 and/or set of predetermined input data 124, as appropriate. In 422, the combined set of input data 122, the set of interpolated input data 126, the set of interpolated input series 128, the interpolation function 140, and/or associated data or information can be stored to the set of operative data 118 in the remote database 116, and/or to other local or remote storage. In 424, as understood by persons skilled in the art, processing can repeat, return to a prior processing point, jump to a further processing point, or end.

According to embodiments of the present teachings, the set of combined input data 122 including the set of predetermined input data 124, the set of interpolated input data 126, as well as the set of target output data 120 and/or other information generated by the interpolation engine 104 and/or other logic can be altered, scaled, adjusted, and/or otherwise manipulated or mapped using one or more weights and/or other inputs supplied by the operator.

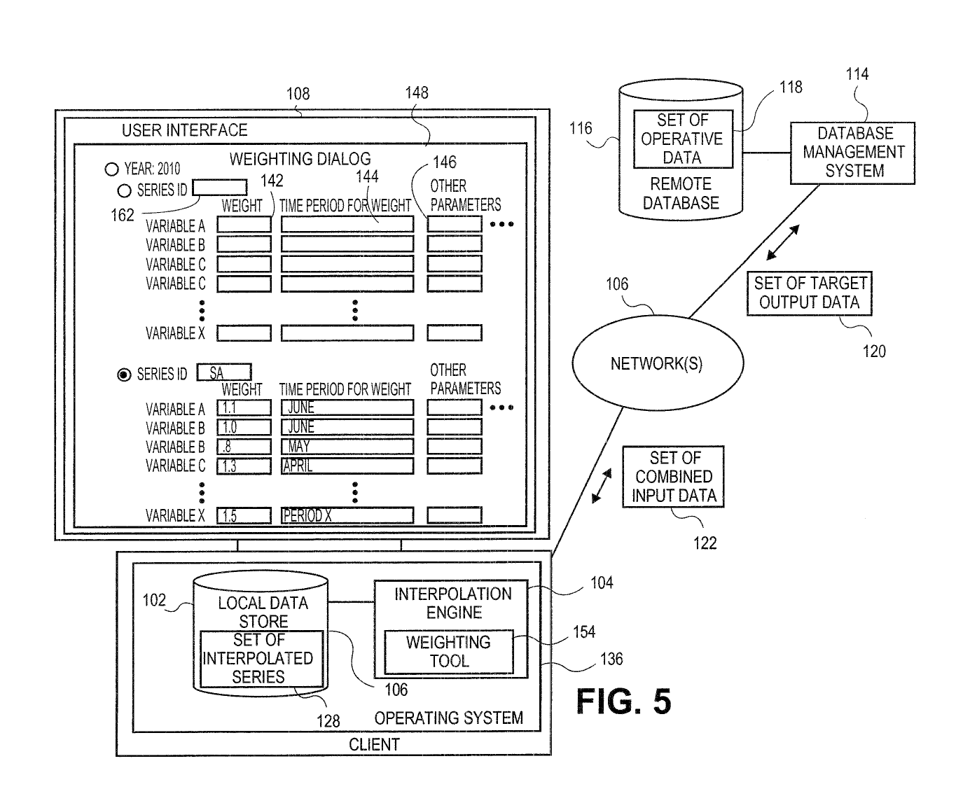

More particularly, and as for shown in FIG. 5, in embodiments, the interpolation engine 104 of client 102 can be configured to host and/or access a weighting tool 154. In aspects, the weighting tool 154 can be or include an application, module, service, and/or other logic to receive and process one or more weights, scalings, and/or other adjustments to predetermined input data and/or other data used in interpolation and/or extrapolation operations, according to the present teachings. In aspects, the interpolation engine 104. weighting tool 154, and/or other logic can generate or manage a weighting dialog 148 to present to a user of client 102, for instance, via the graphical user interface of client 102 and/or using other interfaces.

According to aspects, the weighting dialog 148 can present the user with a variety of dialog and/or input options, such as radio buttons, input boxes, and/or other gadgets or input mechanisms, to receive data including a set of weights 142 to be applied to any data operated upon by interpolation engine 104. The set of weights 142 can be or include, for instance, a set of normalized values specifying an amount by which one or more variables contained in the set of predetermined inputs 124 can be weighted, scaled, and/or otherwise modified. The set of predetermined inputs 124 can take on values, for instance, between 0 and 1, 0 and 2, and/or other ranges or scales, and/or can be expressed in different fashions, such as on a percentage basis.

In aspects, the weighting dialog 148 can also present other variables or parameters for user selection and/or input, including one or more time periods 144. The one or more periods 144 can comprise a time period or periods over which a selected or inputted weight is to be applied. For instance, in a study of housing market trends, the user can specify a weight of 1.2 (i.e, to increase the value or significance by 20%) of prevailing long term interest rates for the third and fourth quarters of 2010. Other time periods, intervals, or durations can be used, and can be specified for one or more variables in the set of predetermined inputs 124, set of interpolated inputs 126, and/or other data, for the same time period and/or for different time periods. In aspects, the weighting dialog 148 can also present and receive inputs for one or more other parameters 146 in connection with interpolation operations, such as user-supplied inputs specifying units, formats, thresholds, and/or other variables or parameters. It may be noted that in aspects, the set of weights 142 can include weights of zero value for variables and/or series which the operator wishes to eliminate from the interpolation analysis.

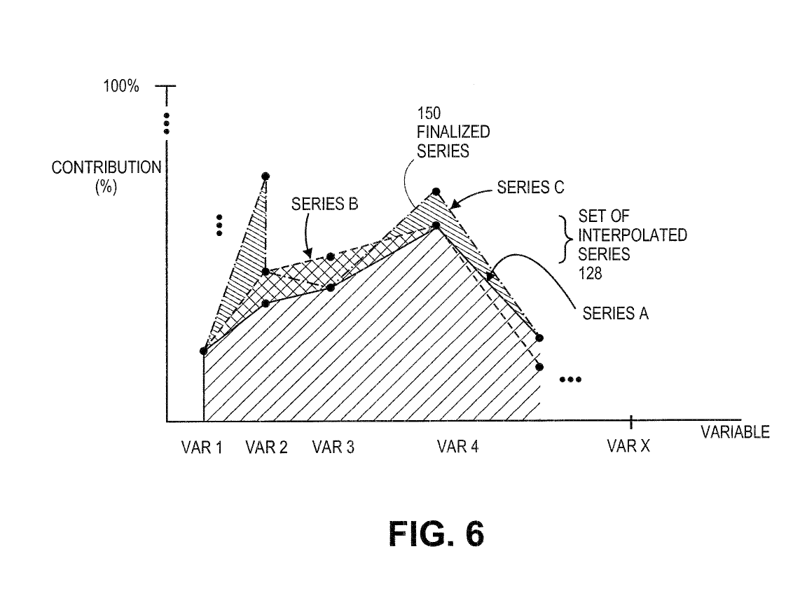

After receipt of any one or more of set of weights 142, one or more periods 144, set of other parameters 146 and/or other data, the interpolation engine 104, weighting tool 154, and/or other logic can apply those weights and/or other adjustments to generate a set of interpolated series 128, including the interpolated inputs and/or other data obtained by generating the set of interpolated inputs 126 using the set of weights 142. The set of interpolated series 128 can include alternative sets of interpolated input data, generated according to different or alternative sets of weights supplied by the operator. The set of interpolated series 128 can thereby include, for example, different series of housing market data for the same year, projected or generated according to different economic variables, such as interest rates, housing stock, average real estate prices, and/or other variables, weighted by the set of weights 142 to produce a range or spectrum of the set of interpolated input data 126, based on those different weights for that year. In embodiments, the weighting dialog 148 can present the user with a choice or selection to select a finalized series 150, such as shown in FIG. 6. If selected, the one or more finalized series 150 can represent the operator's choice or selection from the alternatives present in the set of interpolated series 128 generated by various sets of weights 142, to reflect a desired outcome, output, interpolated input data, and/or other variables or quantities that best balance or meet the desired results. In aspects, the weighting dialog 148 may permit the user to insert the one or more finalized series 150, and/or other data or series in the set of interpolated series 128, back into the data from which the set of combined input data 122 is drawn, in effect to add one or more additional series, as altered and developed by different weightings, to the set of historical or existing data. This can permit any series developed using the set of weights 142 on a hypothetical or constructed basis, to act as additional “real” or empirical data, if the user so chooses.

In aspects, consistent with the foregoing, an operator or user may initiate the interpolation engine 104, weighting tool 154, and/or other logic or services to open the weighting dialog 148 and conduct or construct a study on climate data. In a given year, such as 2009, the set of predetermined input data can comprise variables, parameters, and/or other data such as average ocean temperature of 61.5 degrees F., average continental wind speed of 5.4 mph, ozone layer depth of 2.2 miles, average cloud cover of 35% for that year, an annual precipitation amount of 22.6 inches, the amount of carbon dioxide emissions of 77 million metric tons, the number of tropical storm systems developed that year of 14, and/or other climate or weather-related data, variables, parameters, and/or information. The historical, known, empirical, and/or predetermined data for historical year 2009 can include one or more set of output data, such as the resulting average worldwide land temperature of 66.7 degrees F.

In this merely exemplary scenario, a user operating the weighting dialog 148 to construct a set interpolated series 128 may, for instance, construct a first series by opening the weighting dialog 148 to input a set of weights 142 including a weight of 1.1 for average land temperature, and a weight of 1.3 for the ozone layer depth. The user can then operate the interpolation engine 104, weighting tool 154, and/or other logic to arrive at a series generated by those weights, so that, for instance, after applying those weights, the data for the year 2009 can be re-computed, for instanced to force the same predetermined output data (e.g., average worldwide land temperature of 66.7 degrees F.) to arise as under the original or historical data. In such cases, the interpolation function 140 may be adjusted or re-calculated to apply the user-supplied weights to the selected variables, and generate an accordingly adjusted set of interpolated inputs 126 to compensate or take into account the user-supplied weightings. The user can also or instead apply those weights to create an additional or alternative set of historical data to feed to the interpolation engine 104, such as to create a first, second, and/or additional alternate series for the year 2009. In such cases, all variables or parameters not weighted or adjusted by the user via the set of weights 142 can be maintained at their existing or historical values. In aspects, the user can also or instead derive a new or revised set of interpolated input data 126 for a year for which data is not yet complete or known, such as the following 2010 year, using the same set of weights 142 to alter the set of data for historical year 2009, and/or other years. After performing any one or more weighting operations including one or more sets of weights 142, the operator can as noted elect to identify and/or save at least one of the set of interpolated series 128 as a finalized series 150, and can save that series for further analysis or adjustment by additional weightings and/or other operations.

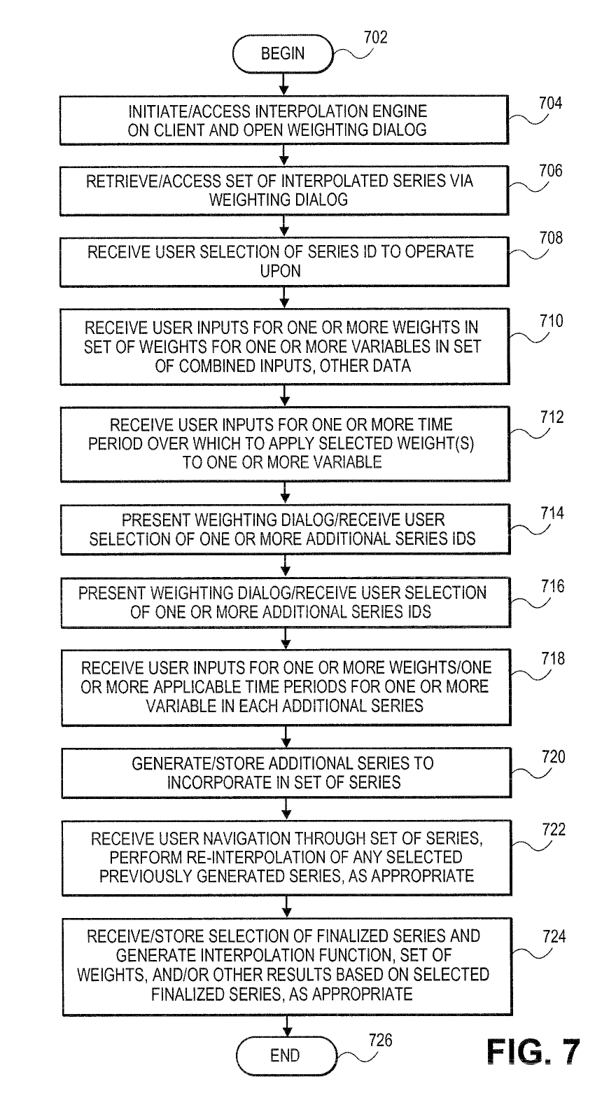

FIG. 7 illustrates an illustration of process flow that can be used in systems and methods for interpolating alternative input sets based on user-weighted variables, according to various embodiments. In 702, processing can begin. In 704, an analyst, operator, and/or other user can initiate and/or access the interpolation engine 104 on the client 102 and/or other platform, and open, initiate, and/or access the weighting dialog 148 via weighting tool 154 and/or other logic, application, service, and/or interface. In 706, the user can retrieve and/or otherwise access the set of interpolated series 128 via the weighting dialog 148 and/or other interface. In aspects, the set of interpolated series 128 can be previously generated by the same and/or different user or users. In aspects, the set of interpolated series 128 can be newly generated upon first use or at other times by the initial user or operator. In 708, the interpolation engine 104, weighting dialog 148, weighting tool 154, and/or other logic can receive a selection from the user of one or more series ID 162 upon which to operate. In 710, the interpolation engine 104, weighting dialog 148, weighting tool 154, and/or other logic can receive user input to specify or one or more weights in the set of weights 142 for one or more individual variables or parameters contained in the set of combined inputs 122, including both the set of predetermined inputs 124 and set of interpolated inputs 126. In aspects, the user may also or instead specify weights to be applied to other variables or data. In 712, the interpolation engine 104, weighting dialog 148, weighting tool 154, and/or other logic can receive user input to specify or one or more time period 144 or periods in which the set of weights 142 shall be applied. For example, in the case of a climate or weather analysis, for the variable for ocean temperature, the user can specify that the ocean temperate shall be weighted by a factor or weight of 1.1 (i.e., increased by 10%) of the first half of year 2009, then weighted by a factor or weight of 1.2 (i.e., increased by 20%) for the second half of year 2010, and then weighted by a factor or weight of 1.4 (i.e., increased by 40%) for all of year 2011. In aspects, the user may also or instead specify time periods, intervals, ranges, and/or durations to be applied to other variables or data. In 714, the interpolation engine 104, weighting dialog 148, weighting tool 154, and/or other logic can generate a set of interpolated inputs 126 to complete a first or initial series of the set of interpolated series 128 based on the user-supplied set of weights 142, one or more time periods 144, and/or other user-supplied weights, scalings, functions, and/or parameters or variables. In aspects, the interpolation engine 104, weighting dialog 148, weighting tool 154, and/or other logic can store the first or initial series as a series in the set of interpolated series 128, for instance to local data store 106, remote database 116, and/or other local or remote storage. In 716, the interpolation engine 104, weighting dialog 148, weighting tool 154, and/or other logic can present the weighting dialog 148 to receive user selection and/or specification of one or more additional series ID 162. In 718, the interpolation engine 104. weighting dialog 148, weighting tool 154, and/or other logic can receive user input(s) for one or more weights in the set of weights 142, one or more time periods 144, and/or other parameter 146 for one or more input variable contained in each additional series.

In 720, the interpolation engine 104, weighting dialog 148, weighting tool 154, and/or other logic can generate and/or store one or more additional series to add to the set of interpolated series 128, as a result of weighting operations. In 722, the interpolation engine 104, weighting dialog 148, weighting tool 154, and/or other logic can receive inputs for user navigation through one or more series in the set of interpolated series 128, and perform any re-interpolation of any previously selected series selected by the user for further weighting and/or other update, as appropriate. In 724, the interpolation engine 104, weighting dialog 148, weighting tool 154, and/or other logic can receive a selection of a finalized series 150 from the user, and generate and/or store the interpolation function 140, the set of weights 142, and/or other results, data, or output based on the finalized series 150, as appropriate. It may be noted that in cases, the user may choose to refrain from choosing a finalized series 150, for instance to continue to generate and analyze additional alternate series in the set of interpolated series 128. In 726, as understood by persons skilled in the art, processing can repeat, return to a prior processing point, jump to a further processing point, or end.

The foregoing description is illustrative, and variations in configuration and implementation may occur to persons skilled in the art. For example, while embodiments have been described in which the interpolation engine 104 comprises a single application or set of hosted logic in one client 102, in embodiments the interpolation and associated logic can be distributed among multiple local or remote clients or systems. In embodiments, multiple interpolation engines can be used. Similarly, while embodiments have been described in which the set of operative data 118 is accessed via one remote database management system 114 and/or a remote database 116 associated with the remote database management system 114, in embodiments, the set of operative data 118 and associated information can be stored in one or multiple other data stores or resources, including in local data store 138 of client 102. Still further, while embodiments have been described in which a unitary weighting tool 154 is hosted in the interpolation engine 104 itself, in embodiments, the weighting tool 154 can be hosted or installed in a different local or remote host machine, logic, and/or service. In embodiments, the weighting tool 154 can comprise a plurality of tools or logic distributed in or over one or more machines, platforms, or services. Other resources described as singular or integrated can in embodiments be plural or distributed, and resources described as multiple or distributed can in embodiments be combined. The scope of the invention is accordingly intended to be limited only by the following claims.

What is claimed:

1. A method of generating series of interpolated input data using user-supplied weights, comprising:
receiving a set of predetermined input data as part of a set of combined input data;
receiving a set of target output data to be generated according to the set of combined input data;
receiving a first set of weights to be applied to at least the set of predetermined input data to generate a first series of interpolated input data, the first set of interpolated input data being generated to conformally map the set of combined input data to the set of target output data;
receiving at least a second set of weights to be applied to at least the set of predetermined input data to generate a second series of interpolated input data, the second set of interpolated input data being generated to conformally map the set of combined input data to the set of target output data;
combining the first series of interpolated input data and the at least second series of interpolated input data to form a set of interpolated series; and
receiving a selection of at least one series from the set of interpolated series to store as a finalized series of interpolated input data.

2. The method of claim 1, wherein at least one of the first set of weights or the second set of weights is received via user input.

3. The method of claim 1, wherein at least one of the first set of weights or the second set of weights is received via an application or service.

4. The method of claim 1, wherein receiving at least a second set of weights comprises a plurality of additional sets of weights to be applied to at least the set of predetermined input data to generate a plurality of additional series of interpolated input data.

5. The method of claim 1, further comprising receiving at least one time period indicating a time period over which at least one of the first set of weights and the second set of weights is to be applied to at least the set of predetermined input data.

6. The method of claim 5, wherein the at least one time period comprises a plurality of time periods.

7. The method of claim 6, wherein the weight assigned to at least one input in the predetermined set of inputs is different for at least two of the plurality of time periods.

8. The method of claim 6, wherein at least two of the plurality of time periods have different values.

9. The method of claim 1, further comprising storing the at least one finalized series as part of the predetermined input data.

10. The method of claim 9, further comprising generating a further set of the set of interpolated series using the at least one finalized series as part of the predetermined input data.

11. The method of claim 1, wherein the set of predetermined combined input data comprises at least one of a set of financial data, a set of medical data, a set of demographic data, a set of engineering data, a set of network operations data, or a set of geographic data.

12. A system for generating series of interpolated input data using user-supplied weights, comprising:
an interface to a database storing a set of target output data and a predetermined set of combined input data, the predetermined set of combined input data comprising—
a set of predetermined input data, and
a set of interpolated input data; and
a processor, communicating with the database via the interface, the processor being configured to—
access the set of predetermined input data,
receive a set of target output data to be generated according to the set of combined input data,
receive a first set of weights to be applied to at least the set of predetermined input data to generate a first series of interpolated input data, the first set of interpolated input data being generated to conformally map the set of combined input data to the set of target output data,
receive at least a second set of weights to be applied to at least the set of predetermined input data to generate a second series of interpolated input data, the second set of interpolated input data being generated to conformally map the set of combined input data to the set of target output data,
combine the first series of interpolated input data and the at least second series of interpolated input data to form a set of interpolated series, and
receive a selection of at least one series from the set of interpolated series to store as a finalized series of interpolated input data.

13. The system of claim 12, wherein at least one of the first set of weights or the second set of weights is received via user input.

14. The system of claim 12, wherein at least one of the first set of weights or the second set of weights is received via an application or service.

15. The system of claim 12, wherein receiving at least a second set of weights comprises a plurality of additional sets of weights to be applied to at least the set of predetermined input data to generate a plurality of additional series of interpolated input data.

16. The system of claim 12, wherein the processor is further configured to receive at least one time period indicating a time period over which at least one of the first set of weights and the second set of weights is to be applied to at least the set of predetermined input data.

17. The system of claim 16, wherein the at least one time period comprises a plurality of time periods.

18. The system of claim 17, wherein the weight assigned to at least one input in the predetermined set of inputs is different for at least two of the plurality of time periods.

19. The system of claim 17, wherein at least two of the plurality of time periods have different values.

20. The system of claim 12, further comprising generating a further set of the set of interpolated series using the at least one finalized series as part of the predetermined input data.
